(19) United States
(12) Patent Application Publication
(10) Pub. No.: US 2014/0109530 A1
(43) Pub. Date: Apr. 24, 2014

(54) Longeing Device

(71) Applicant: Melissa Mihalevich, Kirksville, MO (US)

(72) Inventor: Melissa Mihalevich, Kirksville, MO (US)

(21) Appl. No.: 13/905,070

(22) Filed: May 29, 2013

Related U.S. Application Data
(60) Provisional application No. 61/653,385, filed on May 30, 2012.

(51) Int. Cl. B68B 1/04

(52) U.S. Cl. CPC B68B 1/04
USPC 54/6.1

(57) ABSTRACT

A longeing device for attachment to equine headgear includes a flexing segment having first and second ends. The segment is configured with a length so that when its ends are attached to opposite lateral sides of headgear on an equine head in a normal standing position, the segment's midpoint hangs freely below the head. The segment includes at least one rigid element configured to apply force to a side of the head when the segment is pulled laterally. First and second fasteners, each coupled to a respective first and second end of the flexing segment, couple to attachment points of the headgear.

### CROSS REFERENCE TO RELATED APPLICATION

This application claims priority to and incorporates by reference U.S. Provisional Patent Application No. 61/653,385, titled “Longeing Device”, filed 30 May 2012.

### FIELD OF THE INVENTION

The invention relates generally to equine equipment, and specifically to headgear, and more specifically to devices for attaching a longe line.

### BACKGROUND

A longe is a long rein, strap or line used to lead or guide an animal, such as a horse. A longe is sometimes referred to as a longe line. Longe is typically pronounced the same as lunge, and also sometimes is spelled lunge rather than longe. As a verb, to longe generally means to guide, train or exercise a horse, typically in in a circle, at the end of a longe. Longeing can provide many benefits both for horses and riders, including for teaching and exercise.

Horse trainers and owners use a variety of devices and techniques to teach their horses with a longe and to longe them once taught. Some longe in halters alone; some longe with a stud chain over the nose, around the muzzle, or through the mouth. Horses are sometimes longed in longeing cavessons or in their bridles. When longed in bridles, the owners or trainers sometimes use an attachment called a longeing strap that connects the two sides of the bit together.

Longe lines, which typically are cotton but can be any suitable material, generally have a fastener at one end, such as such as a snap, buckle, chain or clip, that attaches to an animal's headgear, such as a horse's bridle, halter or longeing cavesson. FIG. 1 shows a horse with a prior art cavesson with longe line attached.

### SUMMARY

Certain aspects are set forth below to provide the reader a summary of forms the invention can take. The summary and embodiments of the invention are illustrative, and the invention can encompass embodiments, aspects and details that are not specifically set forth.

An effective way to train an animal such as a horse is to apply a cue in the form of pressure that is released when the horse responds in the desired way. Learning is greatly facilitated when the pressure or cue is clear and specific to the animal, and is released immediately in response to the animal's correct action. Embodiments of the inventions facilitate applying force or pressure, for example to the underside of the horse's jaw when the horse's head moves away from the longe line or lead rope (or when the longe line or lead rope is pulled), and then releasing this force or pressure immediately when the horse responds by turning its head toward the pressure of the longe line or lead rope.

Embodiments of the invention provide a longeing device for attachment to equine headgear that includes a flexing segment. Exemplary flexing segments are metal chains or leather straps, but materials other than metal or leather can be used. Flexing segments can also be made using one or more rigid segments having joints or pivot points allowing for suitably flexible movement. The length of the flexing segment is such that when its ends are attached to opposite lateral sides of headgear on an animal's head in a normal standing position, the segment's midpoint hangs below the head. The segment includes at least one rigid element configured to apply force to a side of the head when the segment is pulled laterally.

In many embodiments the invention includes fasteners at the ends of the flexible segment to couple it attachment points of the headgear, allowing the longeing device to be attached to different items of headgear. In other embodiments the flexible segment can be included as part of the headgear.

In various embodiments the flexing segment includes multiple attachment elements, such as metal rings, for coupling the device to a longe line. The rings can be circular or D-shaped or any other suitable configuration. The attachment element can be separate from or part of the flexible segment. For example when the flexible segment is a chain, it can be a link in the chain or an attachment ring included as a link in the chain, or it can be a separate attachment ring or clip that will be coupled between the longe line and the flexing element.

A rigid element is preferably located on the flexing segment at a location to apply force to an underside of the animal's jaw when the segment is pulled laterally. And to provide versatility, rigid elements preferably are provided on both sides of the midpoint of the segment. When the flexing segment is made from a metal chain or one or more other rigid segments having joints or pivot points, the flexing segment can provide the rigid elements without any added components. In other embodiments, such as a flexing element made from leather or nylon webbing, separate rigid elements can be attached at desired locations.

When a longe line is connected to the flexing segment of the longeing device and either the longe line is pulled or the animal's head moves laterally away from the longe line, then the rigid element will apply force or pressure to the animal's head. The force or pressure is immediately released when the animal responds by moving its head towards the longe line.

The length of the flexing segment can vary based on the size and typical posture of the animal with which it will be used. Nominally a horse's head in a standing position is inclined at about 45 degrees downward from horizontal, although of course as those of skill in the art understand, various horses can significantly vary from this. In various embodiments for equine applications, a desired configuration is for the midpoint of the flexing segment to hang approximately level with the middle of the animal's chin. Based on the locations of the attachment points to the headgear, the length of the animal's head, and the angle at which the animal generally holds its head relative to horizontal, one of ordinary skill can select an appropriate length so that the flexing segment's midpoint will hang as desired during use of the longeing device, for example, approximately level with the animal's chin. In some embodiments the flexing segment can have an adjustable length, such as by the use of leather straps with buckles for length adjustment at the ends of the flexing member. In other embodiments the longeing device includes snap-type fasteners at the ends of the flexing member for facilitating easy attachment and removal from the headgear.

According to aspects of the invention longeing device for attachment to equine headgear includes a flexing segment with a length so that when its ends are attached to opposite lateral sides of headgear on an equine head in a normal standing position, the segment's midpoint hangs freely below the head. The segment includes a rigid element configured to apply force to a side of the head, such as the underside of the jaw, when the segment is pulled laterally. Typically there are rigid elements on either side of the flexing segment's midpoint. Fasteners for attaching to headgear, such as snaps or a strap and buckle, are provided at the ends of the flexing segment, or the flexing segment can be provided as part of the headgear. The flexing segment can include multiple attachment elements, such as 3 or 5 metal rings, for attaching a longe line. Preferably the segment's midpoint is approximately level with the middle of the animal's chin when the longitudinal axis of the head points downward at about 45 degrees. In various embodiments the flexing segment has an adjustable length, and can be made using material such as a metal chain or a leather strap. Links of a chain can provide the rigid element.

According to other aspects of the invention, a method of longeing uses a flexing segment attached on opposite lateral sides of headgear on an equine head. The segment includes a rigid element configured to apply force to a side of the head when the segment is pulled laterally. The flexible segment is attached to the headgear and a longe line is attached to the flexible segment. When the longe line applies lateral force to the flexible segment, the rigid element applies pressure to one side of the animal's head, such as an underside of the jaw. The desired reaction by the animal (movement towards the longe line) immediately removes the pressure.

In variations of the invention, the midpoint of a chain or strap attached to opposite lateral sides of headgear for an animal, such as a horse or a dog, hangs freely below the head when the animal is in a normal standing position. The chain or strap has one or more rigid elements for applying force to a side of the head when the chain or strap is pulled laterally. Fasteners at either end of the chain or strap connect to attachment points on the headgear.

Thus, embodiments of the invention can provide various sizes and attachment points to allow the handler/trainer to select the most appropriate location and level of force or pressure for the individual animal in a given situation. Other various refinements of the features noted above exist in relation to various aspects of the present invention. Further features may also be incorporated in these various aspects as well. These refinements and additional features may exist individually or in any combination. For example, it is within the spirit and scope of aspects of the invention to incorporate the inventive longeing device integrally with a piece of headgear such as a bridle, halter or cavesson. This summary is intended simply to familiarize the reader with certain aspects and contexts of the present invention without limitation to the claimed subject matter.

### BRIEF DESCRIPTION OF THE DRAWINGS

Other features, aspects and advantages of the present invention will become apparent from the following detailed description, which refers to the following drawings, in which:

FIG. 1 illustrates a prior art longeing cavesson with a longe line attached;

FIG. 2 illustrates an embodiment of a longeing device made from sections of twist link chain connected by attachment rings and having snap connectors on the ends;

FIG. 3 illustrates another embodiment made from a single length of twist link chain with adjustable leather straps on the ends and multiple attachment rings connected to various links of the chain;

FIG. 4 illustrates another embodiment made from a single length of twist link chain with snap connectors on the ends and multiple attachment rings similar to FIG. 3;

FIG. 5 illustrates an embodiment made from a leather strap with snap connectors on the ends and studs providing rigid elements;

FIG. 6 illustrates embodiments with flexing members made using rigid metal segments with joints or hinge points;

FIG. 7 illustrates the embodiment of FIG. 4 configured with a length so that the flexing member's midpoint is approximately level with a horse's chin when the horse is in a normal standing position; and

FIGS. 8A-B illustrate the use of the embodiment of FIG. 4 to exert force on an underside of a horse's lower jaw.

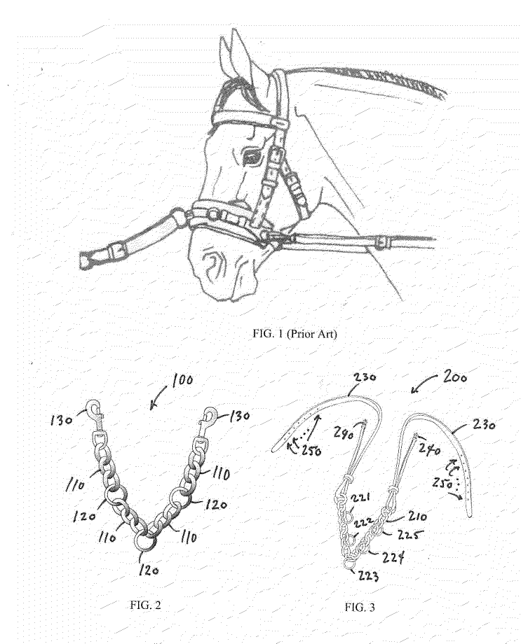

### DETAILED DESCRIPTION OF SPECIFIC EMBODIMENTS

Exemplary embodiments of the inventions according to the disclosure herein provide devices and methods for longeing that are useful for applications such as training and schooling animals, such as horses, in hand and on a longe line. The animal size can vary significantly, for example ranging from ponies to horses (and horses can fall into several categories from small (sometimes called cobs) through large (sometimes called heavy or draft horses)). It will be evident to those of skill in the art how to adapt the teachings of the longeing devices and methods in the various disclosed embodiments to accommodate animals of various sizes.

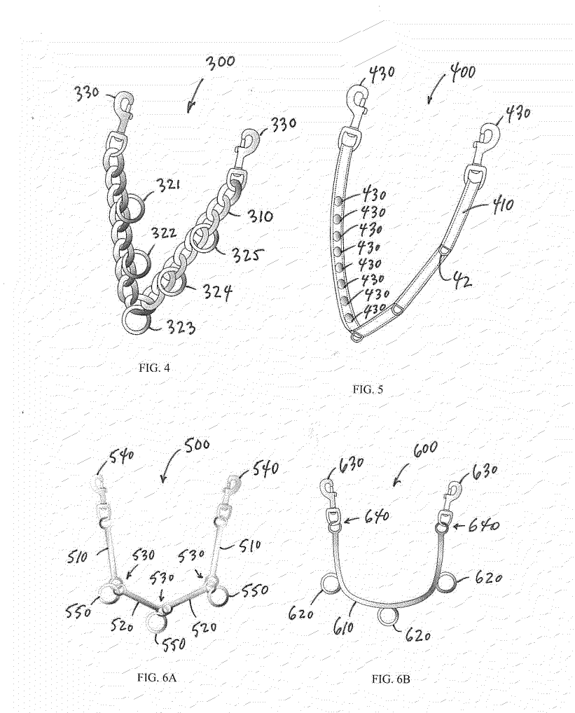

In general, the longeing device embodiments are equipped with a fastener on each end along with several (such as three or five) rings distributed evenly about the center of the longeing device. The longeing devices in the embodiments of FIGS. 2-4 include one or more segments of twist-link chain. While twist-link chain is shown, straight link or other chain types such as rope chain, stud link chain, single or double jack chain, etc., also are suitable. In other embodiments, in lieu of a chain the longeing device can comprise a flexible strap (made for example from leather, nylon, cotton, etc.) with attached rigid members, such as a plurality of hard studs (made for example from metal or hard plastic) as illustrated in FIG. 5.

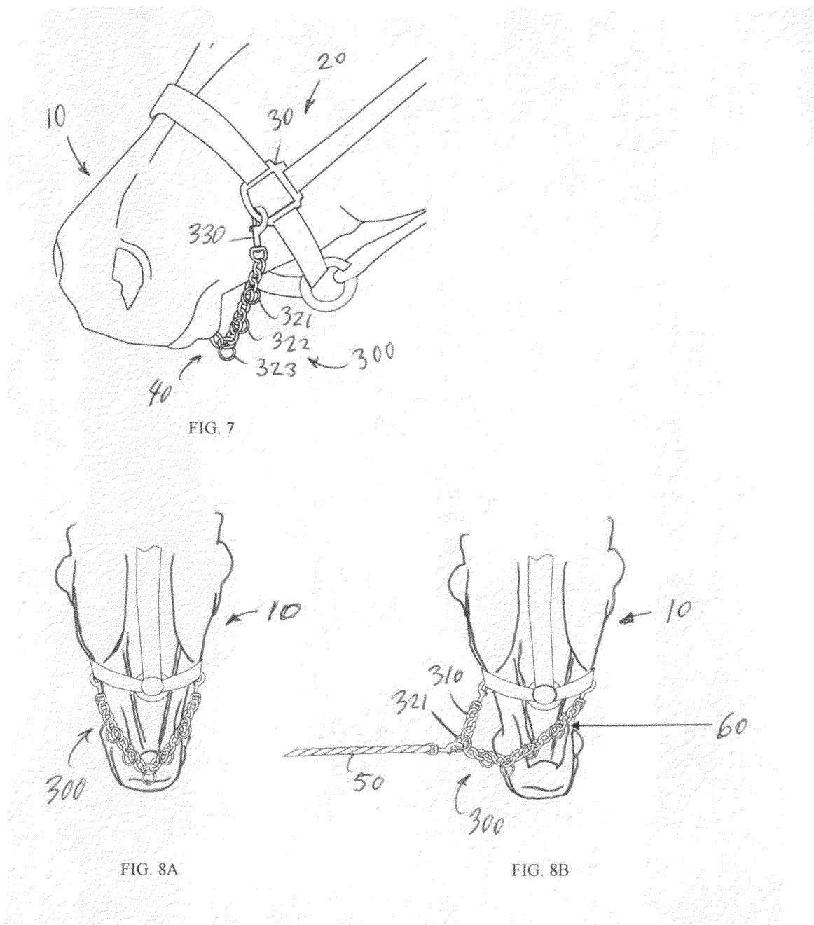

Furthermore as illustrated in the embodiments of FIGS. 6A and B, in lieu of a chain or strap, the longeing device can include rigid metal segments that have at least two hinge or pivot points to allow the longeing device to flexibly move from side-to-side when attached to an animal's headgear. In each case the longeing device is suitably flexible so that when installed it can hang freely down from the animal's headgear as shown for example in the embodiment of FIG. 7.

FIG. 2 shows a longeing device 100 that includes four segments of metal twist-link chain 110 coupled together by three round metal rings 120 that serve as attachment points for a longe line. Together the chain segments 110 and rings 120 provide a flexing segment, which has at its ends snap connectors 130 that facilitate coupling device 100 to headgear such as a bridle or halter (not shown). Variations to the embodiment of FIG. 2 can include removable links coupled between the snap connectors 130 and chain segments 110 to allow for adjusting the length of the flexing segment.

Longeing device 200 in FIG. 3 includes a single segment of metal twist-link chain 210 with five metal attachment rings 221-225, spaced so that ring 223 is at the midpoint of chain 210 and the other rings are generally equally spaced apart. While five longe line attachment rings 221-225 are shown, alternative embodiments can use fewer or more such as three or seven. Adjustable leather straps 230 are provided at the ends of chain 210, which have buckles 240 and holes 250 that conveniently allow for varying the length when attaching device 200 to an animal's headgear such as a halter or at various points. While a leather strap of the type often used for equestrian tack is shown in FIG. 3, those of skill will readily understand how to substitute other adjustable length mechanisms to device 200.

Similar to device 200, longeing device 300 in FIG. 4 also includes a single segment of metal twist-link chain 310 with five longe line attachment rings 321-325. Similar to device 100, device 300 also includes at the ends of chain 310 snap connectors 330 similar to device 100.

Longeing device 400 in FIG. 5 includes a leather strap 410 with five metal D-rings 420 that provide longe line attachment points spaced similarly to the attachment rings of the devices 200 and 300 of FIGS. 3 and 4. Device 400 also includes a plurality of rigid studs 430 coupled to the inside surface of strap 410, the purpose of which is discussed below, as well as snap connectors 440 similar to the snap connectors of devices 100 and 300 of FIGS. 2 and 4.

Longeing device embodiment 500 in FIG. 6 A includes four metal segments: two segments 510 and two segments 520. The four segments 510, 520 are coupled together at three joint or hinge connections 530, formed by interlocking rings at the ends of the segments. Those of skill in the art will understand how to substitute different joint or hinge structures. Snap connectors 540 provide for coupling device 500 to headgear such as a bridle or halter. Device 500 also includes longe line attachment rings 550 coupled at the three hinge points between segments 510 and 520, although optionally these can be omitted and the hinge to allow for attachment of a longe line. Attachment points can be provided in other ways, such as by way of holes, rings, or other fixtures provided elsewhere on segments 520, such as at their midpoints.

Device 600 in FIG. 6B includes a single U-shaped metal segment 610 and three longe line attachment rings 620 connected by metal welding (those of skill will understand that fewer or more longe line attachment points can be provided, and other techniques can be used for providing them such as holes in segment 610). Clips 630 are provided at the ends of segment 610 to provide for attaching device 600 to an animal's headgear. Clips 630 are coupled to segment 610 by universal joints 640 so that segment 610 can swing flexibly with respect to the clips.

In the equestrian context, the longeing devices 100-600 of FIGS. 2 through 6 can conveniently be fastened under a horse's jaw from the left lower halter ring to the right lower halter ring as illustrated by longeing device 300 in FIG. 7. FIG. 7 shows a horse's head 10 fitted with a halter 20, in a nominal standing position (with its head inclined downward at an angle of about 45 degrees). The length of longeing device 300 is chosen so that when attached by clips 330 to lower halter rings 30, the midpoint of longeing device 300 hangs down to a level approximately even with the middle of the horse's chin 40.

Those of skill will understand how to select the length of longeing device 300 based on the size of the horse (ranging from small sizes for ponies to the largest sizes for heavy or draft horses), the location of the attachment points to the headgear, and the angle at which the horse holds its head during use of the longe line. Exemplary ranges of lengths of a longeing device such as longeing device 300 of FIG. 4 are 9 to 12 inches for ponies, 11 to 13 inches for cobs, 12 to 14 inches for typical horses, and 13 to 15 inches for draft horses.

FIGS. 8A-B illustrate operation of the invention using the embodiment of FIG. 4. FIG. 8A essentially shows the same configuration as FIG. 7 of longeing device 300 attached to lower halter rings 30 as seen looking up from the underneath of the horse's head 10. FIG. 8B shows how to use a longe line 50 attached to attachment ring 321 to train or otherwise direct a horse to move in a desired direction.

In this example, the desired response is to cause the horse to change its direction towards the longe line. Pulling the longe line 50 away from the horse's head 10 causes longeing device 300 to apply force to the underside 60 of the horse's jaw as shown in FIG. 8B. The rigid element(s) of the link(s) of the chain 310 will immediately create an unpleasant force on the lower side of the horse's jaw 60 on the side opposite the longe line 50. This will immediately encourage the horse to move in the direction of the longe line 50. As soon as the horse moves in this direction, it will immediately relieve the pressure from the horse's lower jaw 60, providing instantaneous and valuable feedback to the horse.

The same principle applies if it is desired to prevent the horse from moving away from the longe line. Again referring to FIG. 8B, if the horse's head 10 pulls away from the longe line 50, chain 310 will immediately exert unpleasant force on the underside of the jaw 60. As soon as the horse's head 10 moves in the direction of longe line 50, the pressure is removed, providing immediate feedback to the horse.

In the embodiments of FIGS. 2-4, the chain 110, 210, 310 operates as a rigid element to apply pressure to the horses jaw when the horse is not responding to a cue. In the embodiment of FIG. 5, the hard studs 430 provide this element. In the embodiments of FIGS. 6A and B, the metal segments 510, 520, 610 provide the rigid element. In these embodiments, the longeing device is configured to removably attach to the headgear, such as by snaps that allow the user to quickly and easily attach and remove the device from a horse's halter or bridle (in other embodiments the headgear can include a permanently attached longeing device). Also, these embodiments preferably include multiple attachment points such as rings to allow the handler to attach the longe line or lead rope to various locations in order to provide the optimum level of pressure desired for the situation at hand.

The above embodiments provide examples for how use of a chain, strap, or other flexing segment that hangs below a horse's head can provide a means to control the horse when longeing or working in hand by providing the ability to release pressure immediately when the horse responds correctly. As illustrated in FIGS. 8A-B, the handler's cue asking the horse to give its head toward the direction of the cue is transmitted through a longe line or lead rope 50 to the chain by the attachment ring, putting pressure on the far side of the horse's lower jaw 60, which is felt as a request by the horse to respond. Immediately on the correct response by the horse of moving his head toward the pressure, the longeing device 300 loses contact with the horse's jaw and the pressure is taken off. Thus, a horse will be rewarded by the removal of the force for the correct response of moving its head back towards the longe line.

While a longeing rope can be attached to the longeing devices of FIGS. 2-6 without the use of the illustrated attachment rings, the rings shown in these embodiments provide convenient attachment locations. The different attachment locations will result in different force or pressure applied to the animal's head when the longe line applies force. The provision of multiple attachment rings thus provides the handler with flexibility to choose different attachment locations appropriate in difference circumstances or with different animals.

The embodiments of FIGS. 2 and 4-6 provide snaps configured to provide for easy attachment and removal of the longeing device to lower halter rings. In alternative embodiments the length of the chain can be such that the device attaches to upper halter rings or other locations on other headgear. FIG. 3 shows an alternative configuration of adjustable leather straps with buckles that provide added flexibility, for example, when used with a halter, they can pass through the lower halter rings and buckle to the upper side rings on the halter. The adjustable straps allow for adjustment of the length of the longeing device. Any suitable clip or fastener can be used to replace the illustrated snaps of FIGS. 2 and 4-6.

The longeing device should be of sufficient strength to hold up to the rigors of use when restraining the animal for which it is intended, such as a full-grown horse, but must also be small enough to fit under the animal's jaw and be flexible enough to perform its function correctly. An example of a suitable chain material for use with the embodiments of FIGS. 2-4 is machine chain—twist link trade size 4 as defined by the National Association of Chain Manufacturers. For straps in the embodiment of FIGS. 3 and 5, the leather or other strapping material can be the same type of material as is typically used for headgear such as a bridle, halter or longeing cavesson. The snaps or other fasteners and rings should also be of sufficient strength to withstand the potential pressure that can be brought to bear by the animal when in use.

While the longeing device embodiments shown are separate from the headgear, it is within the scope of the invention to include or incorporate the longeing device as part of a halter, headstall, headpiece or headcollar, etc.

Those of skill in the art will appreciate that the inventions may be embodied in other specific forms without departing from the essential characteristics as illustrated in the disclosed embodiments and set forth in the claims. Accordingly, the foregoing is intended to be illustrative, but not limiting, of the scope of the invention, which is to be construed and limited only by the spirit and scope of the following claims.

What is claimed:

1. A longeing device for attachment to equine headgear comprising:
a flexing segment having first and second ends, the segment configured with a length so that when its ends are attached to opposite lateral sides of headgear on an equine head in a normal standing position, the segment's midpoint hangs freely below the head, the segment including at least one rigid element configured to apply force to a side of the head when the segment is pulled laterally; and
first and second fasteners, each coupled to a respective first and second end of the flexing segment, the fasteners configured to couple to attachment points of the headgear.

2. The device of claim 1 wherein the flexing segment comprises a plurality of attachment elements for coupling the device to a longe line.

3. The device of claim 2 wherein the plurality of attachment elements comprises at least three metal rings.

4. The device of claim 1 wherein the rigid element is coupled to the flexing segment at a location to apply force to an underside of the animal's jaw when the segment is pulled laterally.

5. The device of claim 1 wherein the at least one rigid element comprises a first rigid element configured to apply force to a left lower side of the animal's jaw when the segment is pulled laterally in a first direction and a second rigid element configured to apply force to a right lower side of the animal's jaw when the segment is pulled laterally in a second direction 180 degrees opposite of the first direction.

6. The device of claim 1 wherein the segment's midpoint is approximately level with the middle of the animal's chin when the longitudinal axis of the head points downward at about 45 degrees.

7. The device of claim 1 wherein the segment has an adjustable length.

8. The device of claim 1 wherein the segment comprises a metal chain.

9. The device of claim 1 wherein the segment comprises a leather strap.

10. The device of claim 1 wherein the rigid element comprises one or more links of a metal chain.

11. The device of claim 1 wherein the first and second fasteners include snaps.

12. The device of claim 1 wherein the first and second fasteners comprise a strap and a buckle.

13. The device of claim 1 further comprising an item of headgear, and the first and second fasteners are coupled to the headgear.

14. A method of longeing using a flexing segment attached on opposite lateral sides of headgear on an equine head, the segment including at least one rigid element configured to apply force to a side of the head when the segment is pulled laterally, the method comprising:
attaching the flexible segment in conjunction with headgear on an equine head;
coupling a longe line to the flexible segment
using the rigid element to apply pressure to one side of the head in response to a lateral force applied to the flexible segment by the longe line; and
immediately removing the pressure in response to a desired reaction by the animal.

15. The method of claim 14 wherein the region includes a left or right side of the animal's jaw.

16. The method of claim 14 further comprising providing the flexible segment.

17. The method of claim 14 wherein the flexible segment comprises a metal chain with at least 3 attachment rings.

18. The method of claim 14 wherein the flexible segment has an adjustable length.

19. A longeing device comprising:
a chain or flexible strap having first and second ends, the chain or strap configured with a length so that when the ends are attached to opposite lateral sides of headgear on an animal's head in a normal standing position, the midpoint between the two ends of the chain or strap hangs freely below the head, the chain or strap including at least one rigid element configured to apply force to a side of the head when the chain or strap is pulled laterally; and
first and second fasteners coupled to the respective first and second ends, the fasteners configured to couple the chain or strap to attachment points of the headgear.

20. The device of claim 19 wherein the animal is a canine.
